(19) United States
(12) Patent Application Publication
(10) Pub. No.: US 2020/0065923 A1
(43) Pub. Date: Feb. 27, 2020

(54) ELECTRONIC ADJUDICATION SYSTEM

(71) Applicant: Richard Paul Ormond, Los Angeles, CA (US)

(72) Inventor: Richard Paul Ormond, Los Angeles, CA (US)

(21) Appl. No.: 16/549,995

(22) Filed: Aug. 23, 2019

Related U.S. Application Data
(60) Provisional application No. 62/721,770, filed on Aug. 23, 2018.

(51) Int. Cl. G06Q 50/18; G06Q 10/10

(52) U.S. Cl. CPC G06Q 50/18; G06Q 10/10

(57) ABSTRACT

Aspects of the disclosure include systems and methods for electronic adjudication of judicial matters. A system in an aspect of the present disclosure may comprise a network that connects the various actors within a judicial framework, e.g., plaintiffs, defendants, judges, and administrators to provide judicial and/or quasi-judicial determinations of legal disputes.

### CROSS-REFERENCE TO RELATED APPLICATIONS

This application claims priority under 35 U.S.C. 119 to U.S. Patent Application No. 62/721,770, filed Aug. 23, 2019 and entitled “ELECTRONIC ADJUDICATION SYSTEM,” which application is incorporated by reference herein in its entirety.

### BACKGROUND

### Field

Aspects of the present disclosure generally relate to judicial adjudication, and more particularly to an electronic adjudication system.

### Background

The judicial system for adjudicating civil and criminal cases is extremely crowded. In California alone, over six million cases were filed in fiscal year 2015-2016, including over seven hundred thousand civil cases. There were also almost 50,000 more cases filed than resolved in California for fiscal year 2015-2016. This typical backlog of cases to be decided continues to grow in almost every state and federal court in the country. Litigants also spend hours waiting for their cases to be heard even when their case is on the docket for the day.

Filings for court cases are also very complicated. The required format, which forms to fill out and how to fill the forms out correctly for a given matter may be difficult for non-attorneys to determine. As such, many people will employ an attorney to prepare the forms for a case, which increases costs. Many cases with small dollar amounts may not be filed because the cost of an attorney is too high for many people to afford.

Court filings for many courts begin on paper and are then converted to electronic form. Some courts have started electronic filing of cases (also known as “e-filing”) but the practice is not uniform nor is e-filing any easier for the layperson to understand or access.

### SUMMARY

Aspects of the disclosure include systems and methods for electronic adjudication of judicial matters. A system in an aspect of the present disclosure may comprise a network that connects the various actors within a judicial framework, e.g., plaintiffs, defendants, judges, and administrators to provide judicial and/or quasi-judicial determinations of legal disputes.

A system in accordance with an aspect of the present disclosure comprises a headend comprising at least a memory and a processor and an administrative device, coupled to the headend, for providing instructions to the headend related to the dispute, in which at least one of the headend and the administrative device is selectively coupled to at least one plaintiff device, at least one defendant device, and at least one judge device, such that information related to the dispute is selectively delivered to one or more of the at least one plaintiff device, the at least one defendant device, and the at least one judge device, wherein the selective delivery of the information is based at least in part on the instructions provided to the headend.

Such a system further optionally comprises legal disputes, the headend selectively sending information to a selected set of the at least one judge devices, and the selected set being selected based at least in part on input provided by all of the at least one judge devices.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further purposes and advantages, will be better understood from the following description when considered in connection with the accompanying figures. It is to be expressly understood, however, that each of the figures is provided for the purposes of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram that illustrates a hardware environment in accordance with an aspect of the present disclosure;

FIG. 2 illustrates a network with an event logging system in accordance with an aspect of the present disclosure; and

FIG. 3 is a block diagram that illustrates a system in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

### Overview

The present disclosure describes a system for electronic adjudication of disputed matters. In an aspect of the present disclosure may comprise a network that connects the various actors within a judicial framework, e.g., plaintiffs, defendants, judges, and administrators to provide judicial and/or quasi-judicial determinations of legal disputes.

### Hardware Environment

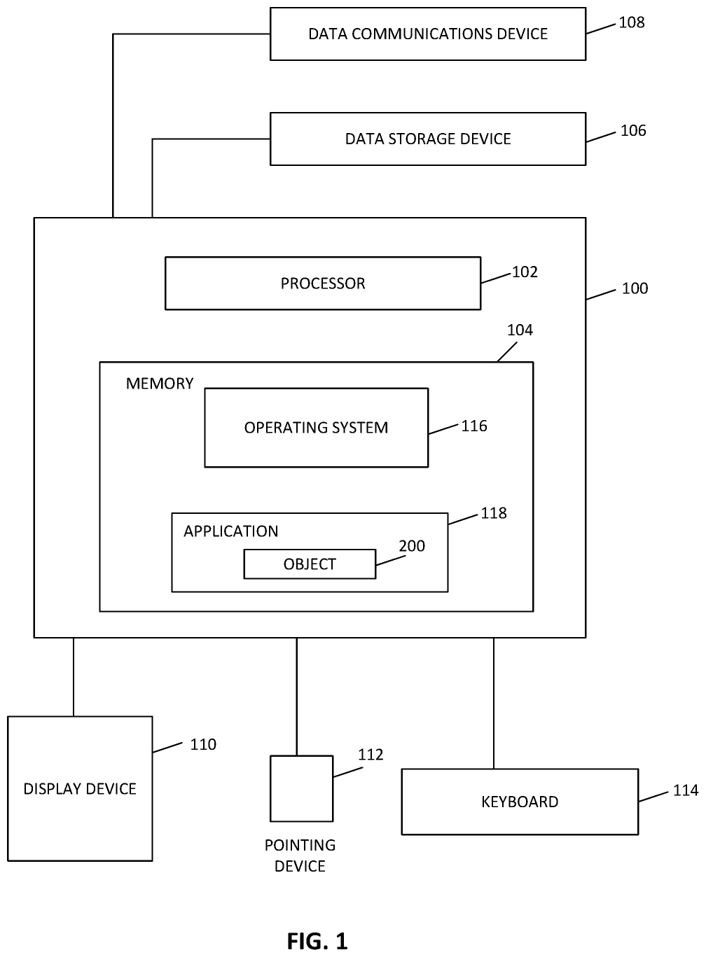

FIG. 1 is an exemplary hardware environment used to implement an aspect of the present disclosure.

The present disclosure may be implemented using a computer 100, which generally includes, inter alia, a processor 102, random access memory (RAM) 104, data storage devices 106 (e.g., hard, floppy, and/or CD-ROM disk drives, etc.), data communications devices 108 (e.g., modems, network interfaces, etc.), monitor 110 (e.g., CRT, LCD display, etc.), mouse pointing device 112 and keyboard 114. It is envisioned that attached to the computer 100 may include other devices such as read only memory (ROM), a video card, bus interface, printers, etc. Those skilled in the art will recognize that any combination of the above components, or any number of different components, peripherals, and other devices, may be used with the computer 100.

The computer 100 usually operates under the control of an operating system 116. The present disclosure is usually implemented in one or more application programs 118 that operate under the control of the operating system 116. The application program 118 is usually a graphics program and/or other program that performs the functions and displays described in various aspects of the present disclosure. In an embodiment of the present disclosure, the application program 118 provides one or more objects 120.

Generally, the application program 118 and objects 120 comprise instructions and/or data that are embodied in or retrievable from a computer-readable device, medium, or carrier, e.g., the data storage device 106, a remote device coupled to the computer 100 via the data communications device 108, etc. Moreover, these instructions and/or data, when read, executed, and/or interpreted by the computer 100 cause the computer 100 to perform the steps necessary to implement and/or use the present disclosure.

Thus, the present disclosure may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope of the present disclosure.

Those skilled in the art will recognize that any combination of the above components, or any number of different components, including computer programs, peripherals, and other devices, may be used to implement the present disclosure, so long as similar functions are performed thereby.

In the present disclosure, a processor, microprocessor, and/or computer may be employed in one or more aspects of the disclosure. The use of a processor, microprocessor, and/or computer in and of itself does not render such aspects of the present disclosure as being directed to a judicial exception to patent-eligible subject matter, i.e., a law of nature, a natural phenomenon, or an abstract idea without significantly more. Further, aspects of the present disclosure may claim patent-eligible applications of the concepts of laws of nature, natural phenomena, and abstract ideas.

For example, and not by way of limitation, the present disclosure is directed toward a patent-eligible concept. Aspects and embodiments of the present disclosure, when taken individually and as an ordered combination, are to be considered when determining whether the additional element(s) transform the nature of the claims of the present disclosure.

The present application comprises something more than organizing human activity, either through the use of a processor, microprocessor, and/or computer, and/or otherwise, because the processor does not organize human activity; the processor in aspects of the present disclosure provides an alternative to the human activity currently employed to adjudicate legal matters, etc., such that a more efficient manner of adjudication may be performed and/or achieved. Such a result has not been available prior to the present disclosure.

Even if the present disclosure may be directed to a patent-ineligible concept, the elements of the present disclosure, both individually and as an ordered combination, are to be considered to determine whether the additional elements transform the nature of the claim into a patent eligible application. The present disclosure comprises an inventive concept sufficient to ensure that the disclosure in practice amounts to significantly more than a patent upon an ineligible concept. Because the judicial exceptions to patent protection of abstract ideas must be construed carefully, applications of such concepts to a new and useful end remain eligible for patent protection within the present disclosure.

Even if in some instances the present disclosure describes concepts that may be directed to an abstract idea and/or another judicial exception, the present disclosure still describes patentable subject matter that remains eligible for patent protection. For example, and not by way of limitation, the present disclosure does not merely apply applicable laws that may be well known in the related art.

Further, the present disclosure describes additional patent-eligible concepts such as a process designed to solve a technological problem in conventional industry practice, and a problem that the industries involved had not been able to obtain previously. Further, the present disclosure is not simply steps previously known and merely implemented on a computer, but feature improvements on an existing technological process. The present disclosure provides solutions and improvements on existing processes that were not previously available.

Because a computer, processor, and/or microprocessor can serve as a patent-eligible structure for a computer-implemented function when the claimed function is coextensive with the microprocessor itself, and a standard microprocessor can serve as sufficient structure for functions that can be achieved by any general purpose computer without special programming, the present disclosure provides such patent eligibility.

### Network Diagram

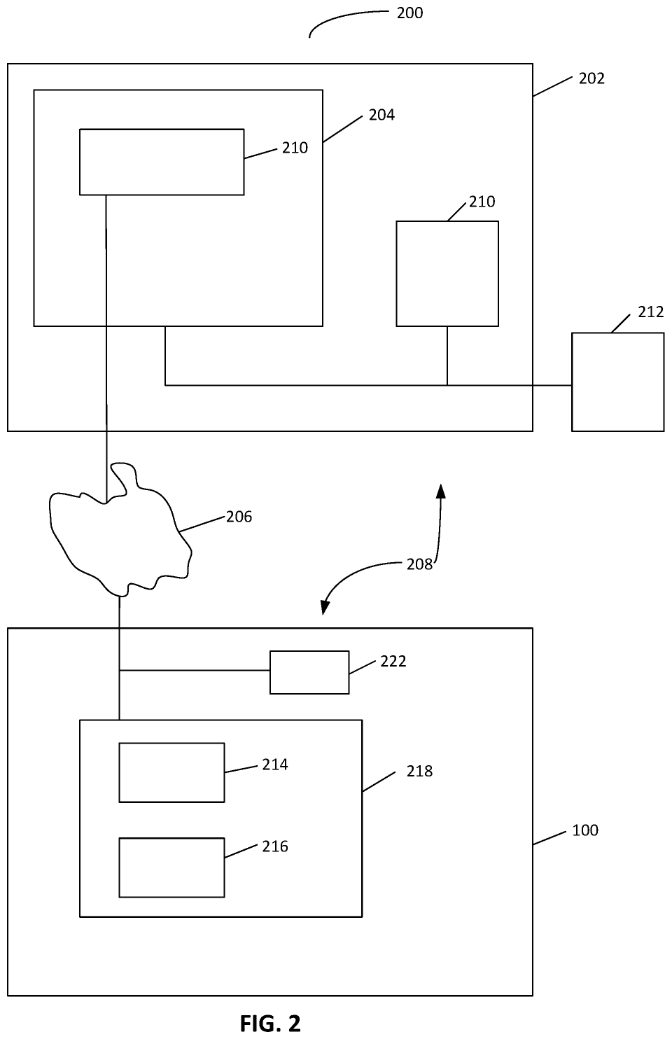

FIG. 2 illustrates a network with an event logging system in accordance with an aspect of the present disclosure.

As shown in FIG. 2, network 200 is embodied as a system having a centralized computer center or headend 202 which is configured to serve content, programs, applications, and/or other services to multiple locations. Such programs and services might include, for example, computer programs, internet pages, video material, audio material, banking services, and/or other services.

A headend 202 may include at least one server 204. As shown in FIG. 2, headend 202 may comprise a plurality of servers 204. The network 200 may have one or more computers 100 and/or other interface devices (also referred to as “user interface units” herein) 100 located at various locations or in a single location such as a home and/or office. The computer(s) 100 receives digital and/or analog signals from headend 202 and controls which programs or services are displayed on computers 100.

Headend 202 is interconnected to the computers 100 via a network structure, which is represented by a network cloud 206. Network 206 may be the internet, which may comprise a fiber-optic and/or cable distribution network that employs digital switching technologies such as asynchronous transfer mode (ATM) for bi-directional communication between the headend 202 and the computers 100. Although a wire-based distribution structure is described, other implementations of network 206 may include satellite communications (e.g., DSS technologies), RF communication, wi-fi, and/or other wireless technologies. The network can also be constructed using a combination of wireless and wire-based technologies without departing from the scope of the present disclosure.

The computer 100 is capable of interacting with the headend 202 in a number of ways depending on which particular service and/or application program computer 100 requests access to. The headend 202 may supply services on an individual basis to the requesting computer 100.

An event logging system, which is referenced generally by numeral 208, may have components distributed throughout the network 200. Some of the components may reside at the headend 202, while other components may reside at the computer(s) 100, and still other components may reside at locations other than the headend 202 and computers 100. Events that may be logged by logging system 208 are initiated at the computer(s) 100 and reported to the headend 202.

The user interface unit 100, and/or the headend 202, determines whether an event is a loggable event. The user interface unit 100 may separate loggable events from non-loggable events to avoid overburdening the network 200. The user interface unit 100 can be configured to choose different groupings of events for logging.

Loggable events are reported to the headend 202 over the distribution network 206. The event logging system 208 is designed so that the user interface unit 100 does not need to know the exact location of any user interface unit 100 to report the events to the headend 202. The headend 202 selects an appropriate database 210, 212 to store event information pertaining to the reported events. An appropriate database 210, 212 may be selected based upon the kind of events being logged. The event logging system 208 may also be designed to permit an operator and/or administrator to configure which database 210, 212 the events are actually logged to promote flexibility in resource allocation. The selected database 210, 212 might be located at the headend 202 or another location.

The event logging system 208 has an event evaluator 214 that resides at the user interface unit to perform an initial event screening. The event evaluator 214 determines whether an event occurring at the user interface unit 100 is a loggable event or a non-loggable event. Routine operation of the user interface unit 100 gives rise to many possible events, but not all of the events will be recorded or logged in network 200.

To assist in making a determination, an event filter criteria 216 is stored in memory 218 at the user interface unit 100 to specify which events are to be logged. The event filter criteria 216 can be configured by the headend 202 to enable or disable specific subsets of events so that only enabled events are reported. Disabled subsets of events are considered to be non-loggable events and are not recorded. In one aspect of the present disclosure, the event filter criteria 216 contains sets of bit flags that are set if the corresponding event kind is to be logged. It is further noted that the headend 202 can enable or disable the event evaluator 214 entirely to thereby turn off all event logging for that user interface unit 100.

Events may be categorized into three primary classes: system events, security events, and application specific events. “System events” may be related to the operation of the system and/or network 200. Examples of system events include excessive network errors, failure in a system service, or failure to start a logon application. “Security events” concern the security of the network 200. Examples of security events include use of an incorrect password by a user logging into a user interface unit 100, or authentication failures when attempting to authenticate a user during a transaction over the network 200. “Application events” concern operation of applications running on the user interface units 100. An example of an application event might be input to the user interface unit 100 that is sent to the headend 202 while the user is in the application.

Events may also categorized into three general types: informational, warning, and error events. “Informational events” may be used for reporting and for debugging purposes as well as to report the general status of a given matter. “Warning events” may be used to report problems that are not immediately troublesome, but which might indicate a more dangerous problem in the future for a given matter. For example, an application may report a warning event at the user interface unit 100 when the user interface unit 100 is running out of resources, or when a deadline is approaching and input to network 200 has not been received. “Error events” are used to report a problem that results in a loss of functionality or data. Examples of error events include an application failing to load or a system service failing to start. Error events are most likely to occur infrequently within network 200.

In addition to the classes and types just described, each event can be assigned a degree of importance or importance level. The importance level may be a binary value (e.g., 16-bit) that is attached as the upper bits to the binary value representing the specific event. The importance level is used to partition events in such a way that a system administrator can selectively determine the level of events that are reported to the headend 202 from a particular event source.

The events are detected at the user interface unit 100 in various ways. For instance, the processor 222 (which may be part of, additional to, and/or concurrent with processor 102) can electronically track when the user inputs a file to the system to detect application events, or when a user enters a wrong password to detect security events. Interrupts are one common way to make the processor 222 aware of events, although there are other known techniques for alerting the processor 222 to possible events.

The event logging system 208 also may have an event log manager 220 resident at the headend 202 or elsewhere in network 200 to manager where events are to be logged. The event evaluator 214 at the user interface unit 100 reports the loggable events over the distribution network 206 to the event log manager 220. The event log manager 220 may be a program that executes on one or more of the servers 204 that make up the server system 204. The event log manager 220 can be dynamically moved about the servers at the headend 202 as resources change, without affecting operation of the event logging system.

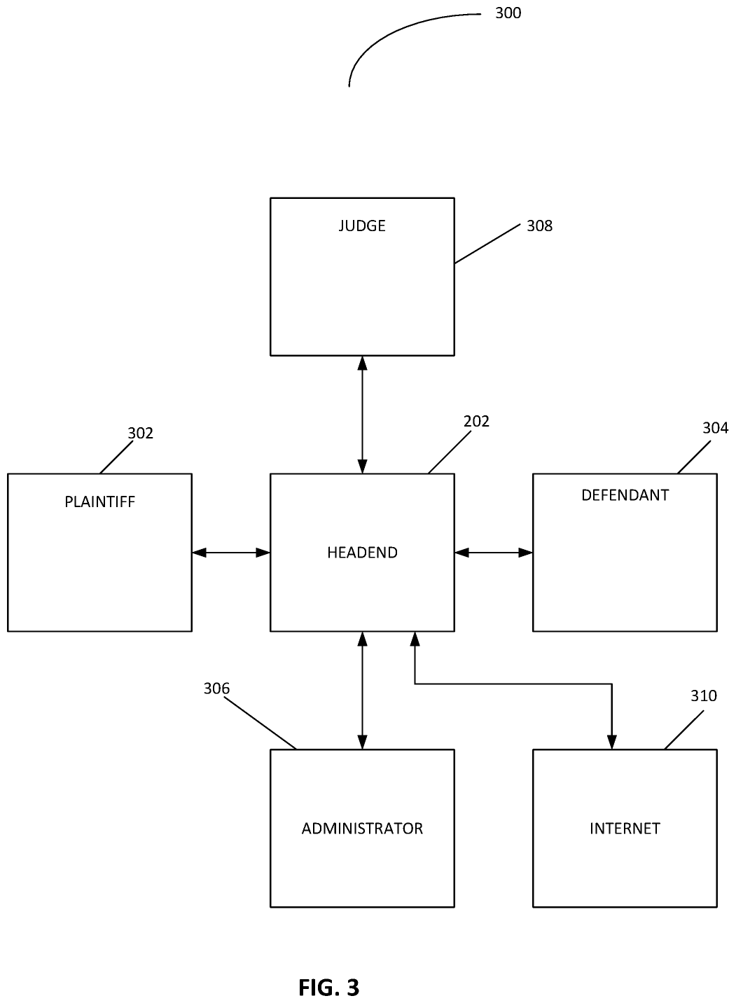

FIG. 3 is a block diagram that illustrates a system in accordance with an aspect of the present disclosure.

System 300, which may be an embodiment of system 100 and/or network 200, illustrates how headend 202 interfaces with various parties in an aspect of the present disclosure. When a plaintiff 302 wishes to file a lawsuit, plaintiff 302 activates an application (which may be downloaded onto plaintiff's computer and/or be an application that is stored in the cloud and only accessed when any participant is actively using the application) and enters information into a computer/user interface unit. Some of that information may be, for example, the name of the defendant 304, the address and/or email address of the defendant 304, the nature of the lawsuit, etc., in a similar fashion to a complaint in the legal system. The plaintiff 302 may also be asked to pay a filing fee to enter the information into system 300, which may connect plaintiff 302 to the internet 306 to electronically transfer funds from plaintiff's accounts, e.g., banking accounts, bitcoin, PayPal® account, Venmo® account, etc. to administrator 308 and/or to the owner/operator of system 300. Upon completion of the plaintiff's 302 input and/or payment, headend 202 logs this event as a “filing” of the complaint and notifies the administrator 308 that a plaintiff 302 has accessed the system 300 and opened a “case” for system 300 to handle.

Administrator 308 acts in a similar fashion to the “clerk” of a court. Administrator 308, which may be a human and/or artificial intelligence review, reviews plaintiff's 302 complaint, and, based on the subject matter of the complaint, the amount in controversy, and/or other characteristics of the complaint, administrator 308 assigns a judge 310 to the matter.

For example, and not by way of limitation, plaintiff 302 may indicate what type of lawsuit plaintiff believes their suit to be, e.g., real estate, contract, family law, etc., when entering information into system 300. When plaintiff's 302 suit is submitted to system 300, administrator 308 reviews the indications of the type of complaint, and locates a judge 310 that has the requisite knowledge, etc. to adjudicate the matter submitted by plaintiff 302.

Administrator 308 may accept applications from judge(s) 310 and input one or more entries in system 300 to indicate what subject matter(s) each judge 310 would be allowed to adjudicate within system 300. For example, and not by way of limitation, administrator 308 may only accept applications to be a judge 310 from licensed attorneys in the jurisdiction that have at least ten years of experience and do not have any disciplinary actions recorded against them. Some applicants to be a judge 310 in system 300 may be familiar with family law issues; such judge(s) 310 would have an indication in their system 300 profile that indicates proficiency in family law matters. When a plaintiff 302 enters data, e.g., radio button, key word, menu selection, etc. into system 300 as part of the complaint indicating that the matter is a family law matter, system 300, via administrator 308 (either as a human interaction with system 300 and/or automatic function programmed into system 300) may send that judge 310 a notification that a matter is available for adjudication. System 300 may send a plurality of judges 310 a notification that a matter is available for adjudication based on each judge's 310 qualifications and/or other characteristics, e.g., known conflicts, similar cases, previous cases accepted, and/or other parameters. If the judges 310 that are so notified are interested in adjudicating the matter, each judge 310 may send a reply to system 300, vis-à-vis administrator 308, that they are willing to hear the matter submitted by plaintiff 302. System 300 may then forward the party names and/or other information as needed by judge(s) 310 to ensure that no conflicts of interest are present which may disqualify one or more judges 310 from hearing that particular matter. System 300 may then select a judge based on one or more parameters, e.g., first judge 310 to clear conflicts, first judge 310 to respond to the initial request, caseload for the various judges 310 in system 300, and/or other parameters.

Administrator 308 may also send electronic and/or physical correspondence to defendant 304 to inform defendant 304 about the complaint filed by plaintiff 302. Plaintiff 302 may also be required to provide proof of service upon defendant 302 before a judge is assigned by administrator 308.

Administrator 308, as a human interaction with system 300 and/or as an automatic feature of system 300, may use optical character recognition (OCR) and/or other imaging techniques to assist in assigning cases to various judges 310 within system 300. Administrator 308 may also accept inputs from prospective judges 310, similar to judge pro tem positions in the current court system, where practicing lawyers act as judges on a temporary and/or on call basis. Administrator 308 may evaluate the capabilities and/or experience of prospective judges 310 and only assign certain cases to those judges 310.

Administrator 308 may also be partially and/or completely automated and require little or no human interaction to perform the functions of administrator 308. For example, and not by way of limitation, in the complaint filed by plaintiff 302, a check box and/or input to system 300 may indicate that the matter plaintiff 302 wishes system 300 to adjudicate is a medical malpractice matter. Administrator 308 may automatically eliminate some judges 310 that are available within system 300 because those judges 310 may not have the jurisprudence necessary to adjudicate a medical malpractice case, and/or because some judges 310 may need to be recused for various reasons. Administrator may then select a judge 310 from the remaining judges 310 registered in system 300 based on assigned case load in system 300 and/or other reasons which may be computer-generated or decided through human interaction with system 300.

Defendant 304 may then provide an answer to plaintiff 302 via system 300. The answer to the complaint may also be logged by system 300 to show that defendant 304 has received the complaint and has submitted to jurisdiction of system 300 for the matter at hand.

System 300 may use forms and/or questionnaire-style inputs to make system 300 less “formal” than a trial court setting. For example, and not by way of limitation, plaintiff 302 may be limited to a certain number of words and/or pages to explain their side of the dispute; similarly, forms may also be used for the complaint, answer, discovery, etc. to reduce the formality and/or formal rules of a court. For example, and not by way of limitation, small claims courts may not strictly adhere to the rules of evidence and/or the rules of discovery that are required in Federal Courts. Similar relaxations of the rules of civil procedure and/or enforcement of the rules of civil procedure, may be used in system 300 without departing from the scope of the present disclosure. Further, plaintiff 302 and/or defendant 304 may wish to keep attorneys' fees down and choose to relax the rules for a given matter, and thus may opt to relax the rules of civil procedure by agreement for a certain matter.

System 300 may then log the various events that occur in a given matter: complaint, answer, assignment of judge, time for and production of discovery, etc., as well as generate timelines for each party to perform the next step in the process. For example, and not by way of limitation, system 300 may log the complaint filed by plaintiff 302 on day 1. System 300 may then log service of process on defendant 304 on day 6. The logging of service of process on day 6 may then generate a notice to plaintiff 302, defendant 304, administrator 308, and/or judge 310 that defendant 304 has twenty-one days to answer (i.e., by day 27). If defendant 304 has not filed an answer in system 300 by day 28, system 300, vis-à-vis administrator 308 and/or judge 310, may automatically enter a default judgment against defendant 304.

System 300 may be used in conjunction with, as a replacement for, and/or as an alternative to the current court system for adjudication. Plaintiffs 302 and defendants 304 may agree, in a similar manner to that of binding arbitration, that system 300 may adjudicate their matter in lieu of going to a physical courthouse with attorneys and the formalities of a trial. Similarly, the court system, currently overburdened, may use system 300 to adjudicate various matters that are already on file and merely waiting for a time to be heard by a sitting judge.

System 300 may also be used as a “what does the evidence say?” test case, in a similar fashion to non-binding arbitration, to quickly determine what a judge 310 will say before going to the expense and time of the physical courthouse and attorney's time and efforts. Plaintiffs 302 and defendants 304 may input their sides of the dispute into system 300, which may assign an “electronic” judge 310 to adjudicate the dispute. Optical character recognition, as well as artificial and/or programmed intelligence that is placed into “electronic” judge 310 as part of system 300, can give an estimate as to who will win and how much, in a similar fashion to an experienced attorney being able to give an approximation of success and damage award given the facts of a case.

As shown in FIG. 3, system 310 may also trigger alerts that may be forwarded to one or more parties 302, 304, 308, and/or 310. The alerts, such as a reminder to file an answer, etc., may be sent to one or more devices 100, which may include one or more electronic devices, one or more wearable devices, one or more computers, one or more handheld devices, and/or any combination thereof.

The one or more devices may also be configured to operate the within the network 200 and/or perform the steps of application 118. For example, and not by way of limitation, once an alert is received at a given device 100, that device 100 may send data, commands, etc., to headend 202 to provide additional data to the device 100. The network 200 may generate an alert and also sending one or more visual depictions, data relating to the one or more visual depictions, the environment data, and/or any combination thereof. The alert may include the one or more visual depictions, data relating to the one or more visual depictions, the environment data, and/or any combination thereof.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a view of the device as shown in the present disclosure. Of course, if the device is inverted, above becomes below, and vice versa. Additionally, if oriented sideways, above and below may refer to sides of a device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, and algorithm steps described in connection with the disclosure herein may be implemented as various different types of materials and/or various different combinations of materials. To clearly illustrate this interchangeability, various illustrative components, blocks, modules, and steps have been described above generally in terms of their functionality. The various materials and/or combinations of materials employed to implement the present disclosure depends upon the particular application and design constraints imposed on the overall system. Skilled artisans may implement the described functionality in varying ways for each particular application, but such implementation decisions should not be interpreted as causing a departure from the scope of the present disclosure.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. A system for adjudicating a dispute, comprising:
a headend comprising at least a memory and a processor; and
an administrative device, coupled to the headend, for providing instructions to the headend related to the dispute, in which at least one of the headend and the administrative device is selectively coupled to at least one plaintiff device, at least one defendant device, and at least one judge device, such that information related to the dispute is selectively delivered to one or more of the at least one plaintiff device, the at least one defendant device, and the at least one judge device, wherein the selective delivery of the information is based at least in part on the instructions provided to the headend.

2. The system of claim 1, in which the dispute is a legal dispute.

3. The system of claim 2, in which the headend selectively sends information to a selected set of the at least one judge devices.

4. The system of claim 3, in which the selected set is selected based at least in part on input provided by all of the at least one judge devices.
